(19) United States
(12) Patent Application Publication
(10) Pub. No.: US 2019/0133241 A1
(43) Pub. Date: May 9, 2019

(54) LIGHT-EMITTING SHOE

(71) Applicant: Szu-Chi Chou, TAICHUNG CITY (TW)

(72) Inventor: Szu-Chi Chou, TAICHUNG CITY (TW)

(21) Appl. No.: 15/831,720

(22) Filed: Dec. 5, 2017

(30) Foreign Application Priority Data
Nov. 7, 2017 (TW) 106216524

(51) Int. Cl. A43B 3/00; F21V 8/00

(52) U.S. Cl. CPC A43B 3/001; G02B 6/0006

(57) ABSTRACT

A light-emitting shoe includes a shoe body including an upper made up of a woven fabric composed of warp yarns, weft yarns and fiber optic yarns and a shoe sole mounted to a bottom side of the upper and having an accommodation chamber shielded by the upper, and a light source mounted in the accommodation chamber of the shoe sole of the shoe body and connected to one end of each fiber optic yarn for emitting light into the fiber optic yarns so that the emitted light of the light source is evenly distributed throughout the upper of the shoe body via the fiber optic yarns to produce a wide range of light-emitting effect.

### BACKGROUND OF THE INVENTION

### 1. Field of the Invention

The present invention relates to shoe technology, and more particularly to a light-emitting shoe, which utilizes a light-emitting woven fabric for producing a wide range of light-emitting effect throughout the upper.

### 2. Description of the Related Art

The most common light-emitting shoes are mainly to provide a light-emitting device in the interior of the shoe sole, so that the light emitted by the light-emitting device can penetrate through the shoe sole to produce a warning effect or to enhance the visual effect. However, because of the visible light-emitting range of the shoe sole is limited range, the luminous effect of these conventional light-emitting shoes is not ideal. Further, if you want to enhance the brightness, you should have to increase the number of light-emitting devices or to use high intensity light-emitting devices, but this will result in increased power consumption.

### SUMMARY OF THE INVENTION

The present invention has been accomplished under the circumstances in view. It is the main object of the present invention to provide a light-emitting shoe that increases light-emitting surface area, reduces power consumption, and enhances visual or warning effects.

To achieve this and other objects of the present invention, a light-emitting shoe comprises a shoe body and a light source. The shoe body comprises an upper, and a shoe sole mounted to the bottom side of the upper. The upper is made up of a woven fabric composed of a plurality of warp yarns, a plurality of weft yarns and a plurality of fiber optic yarns. The shoe sole comprises an accommodation chamber shielded by the upper. The light source is mounted in the accommodation chamber of the shoe sole of the shoe body and connected to one end of each fiber optic yarn for emitting light into the fiber optic yarns so that the emitted light of the light source is evenly distributed throughout the upper of the shoe body via the fiber optic yarns.

It can be seen from the above that the woven fabric used in the light-emitting shoe can evenly distribute the light emitted by the light sources throughout the upper to produce a wide range of light-emitting effect. Thus, the invention not only can effectively reduce power consumption, but also can produce a warning effect when the user is walking at night.

Preferably, the light-emitting shoe further comprises a battery and a circuit board mounted in the accommodation chamber of the shoe sole of the shoe body. The circuit board is electrically coupled with the battery and the light source. The shoe body further comprises a tongue stitched to the upper, and a light source switch mounted to the tongue and electrically connected to the circuit board. Thus, the light source is controllable by the circuit board to perform various light-emitting modes, for example, the mode of continuously emitting one single color of light without flashing, the mode of flashing in one single color, or the mode of alternatively emitting two colors of light, achieving the purpose of providing enhanced visual effects.

Preferably, the upper of the shoe body comprises a counter, and an opening located in one side of the counter in communication with the accommodation chamber of the shoe sole. The fiber optic yarns have respective one ends thereof gathered together and then inserted through the opening and connected to the light source, simplifying the tracing of the fiber optic yarns.

Other and further benefits, advantages and features of the present invention will be understood by reference to the following specification in conjunction with the accompanying drawings, in which like reference characters denote like elements of structure.

### BRIEF DESCRIPTION OF THE DRAWINGS

FIG. 1 is an oblique top elevational view of a light-emitting shoe in accordance with the present invention.

FIG. 2 is an exploded view of the light-emitting shoe in accordance with the present invention.

FIG. 3 is a circuit block diagram of the light-emitting module of the light-emitting shoe in accordance with the present invention.

FIG. 4 illustrates the woven structure of the woven fabric used in the light-emitting shoe in accordance with the present invention.

### DETAILED DESCRIPTION OF THE INVENTION

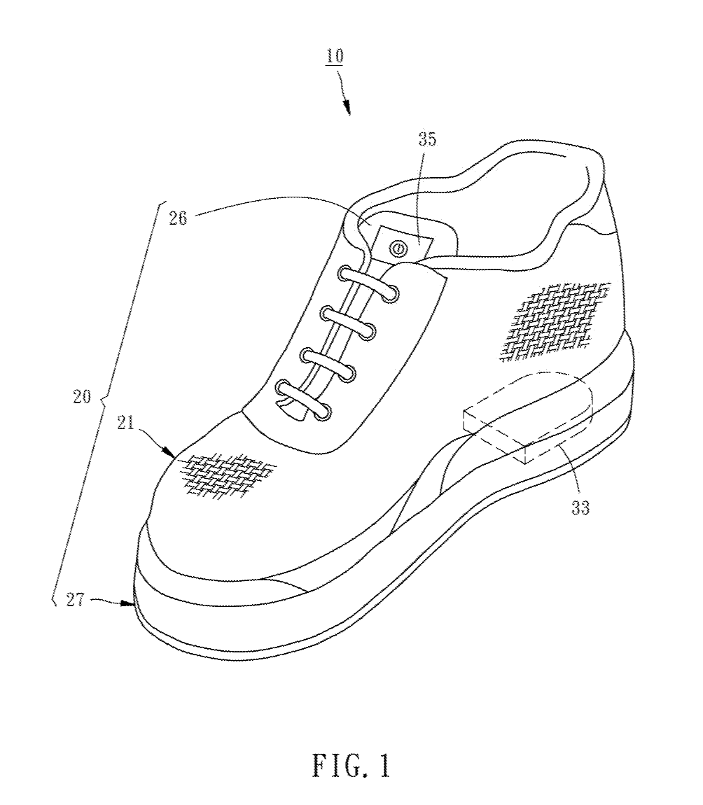

Referring to FIGS. 1, 2 and 4, a light-emitting shoe 10 in accordance with the present invention is shown. The light-emitting shoe 10 comprises a shoe body 20 and a light-emitting module 30.

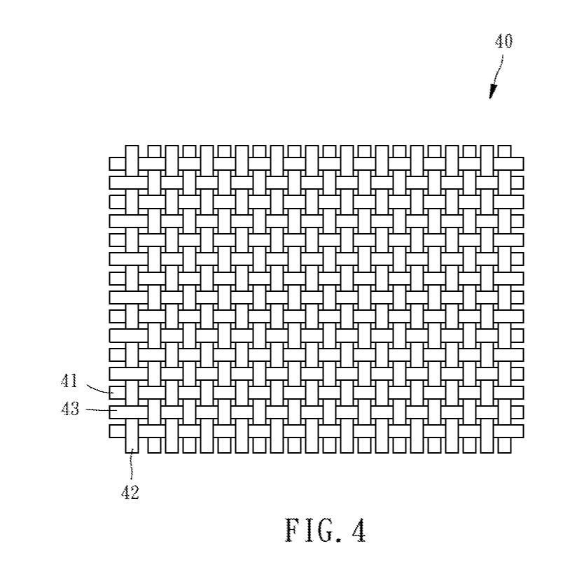

The shoe body 20 comprises an upper 21 made up of a woven fabric 40 composed of a plurality of warp yarns 41, weft yarns 42 and fiber optic yarns 43. In this embodiment, as illustrated in FIG. 4, each warp yarn 41 and each fiber optic yarn 43 are interlaced with the weft yarns 42, the warp yarns 41 and the fiber optic yarns 43 are alternatively interlaced with the weft yarns 42. In terms of material, the warp yarns 41 and the weft yarns 42 can be selected from chemical fibers, animal fibers or plant fibers without limitation.

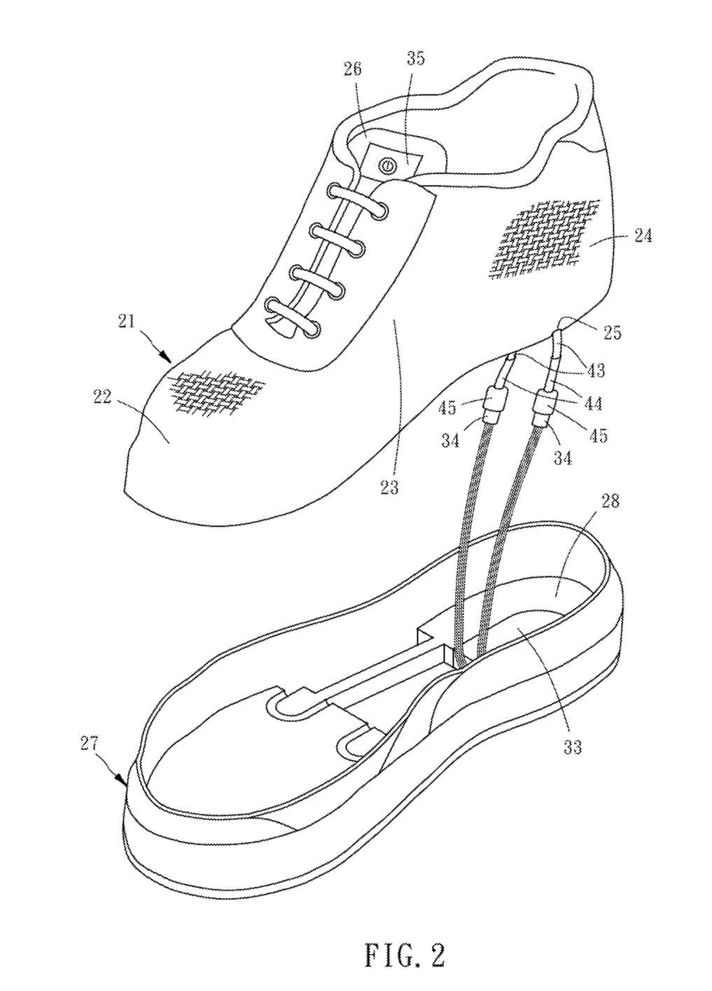

As illustrated in FIG. 2, from front to back, the upper 21 is divided into a toe box 22, a vamp 23 and a counter 24. Further, the upper 21 comprises an opening 25 at each of opposing left and right sides of the counter 24. The shoe body 20 further comprises a tongue 26 and a shoe sole 27. The tongue 26 is stitched to the vamp 23 of the upper 21. The shoe sole 27 is affixed to a bottom side of the upper 21, comprising an accommodation chamber 28 located in a top side thereof and shielded by the upper 21. The accommodation chamber 28 is disposed in communication with the two openings 25 of the counter 24 of the upper 21. Respective one ends of the fiber optic yarns 43 are inserted through the openings 25 and gathered into two beams by two beam tubes 44, and then the two beams of the fiber optic yarns 43 are inserted into the inside of the accommodation chamber 28. Thus, the tracing of the fiber optic yarns 43 is simplified.

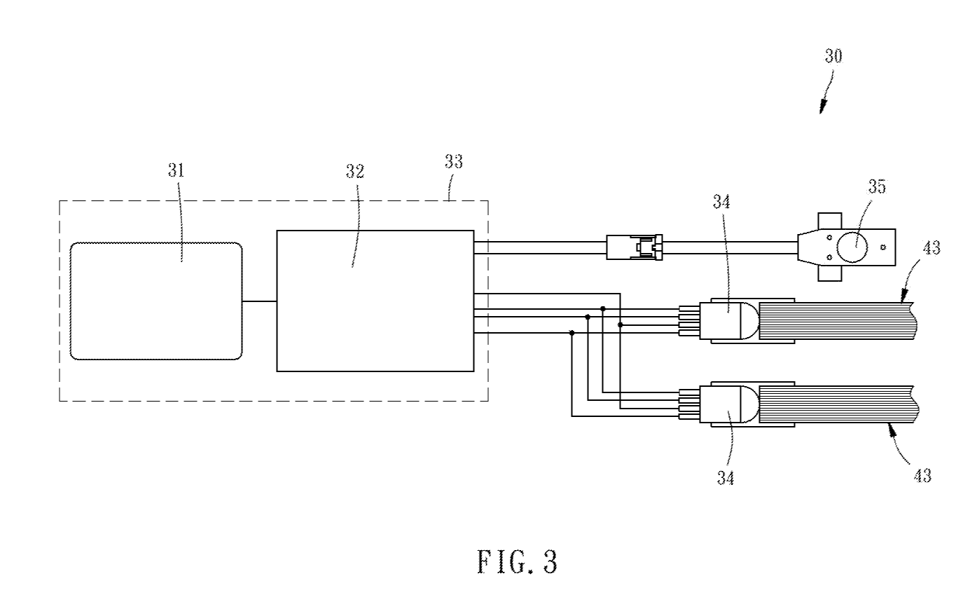

Referring to FIG. 3 and FIG. 2 again, the light-emitting module 30 comprises a battery 31, a circuit board 32, two light sources 34 and a light source switch 35. The battery 31 and the circuit board 32 are electrically connected and then mounted in a control box 33. The control box 33 is mounted in the accommodation chamber 28 of the shoe sole 27 of the shoe body 20. The light sources 34 in this embodiment are, but not limited to, light-emitting diodes. The light sources 34 are mounted in the accommodation chamber 28 of the shoe sole 27 of the shoe body 20 and electrically connected to the circuit board 32. Thus, the light sources 34 are controllable by the circuit board 32 to perform various light-emitting modes, for example, the mode of continuously emitting one single color of light without flashing, the mode of flashing in one single color, or the mode of alternatively emitting two colors of light. Further, the two light sources 34 are respectively connected to the two beams of fiber optic yarns 43 by a respective buckle 45. Thus, the light beams emitted by the two light sources 34 can be transferred through the two beams of fiber optic yarns 43 to the upper 21 of the shoe body 20. Further, the light source switch 35 is mounted to the tongue 26 of the shoe body 20 and electrically connected to the circuit board 32, on the one hand for turning on/off each light source 34 and, on the other hand for switching the light-emitting mode of the light sources 34.

It can be seen from the above that the woven fabric 40 used in the light-emitting shoe 10 of the present invention can evenly distribute the light emitted by the light sources 34 throughout the upper 21 to produce a wide range of light-emitting effect without increasing the number of the light sources 34 or using high intensity light sources. Thus, the invention not only can effectively reduce power consumption, but also can produce a warning effect when the user is walking at night. Further, through the switching control of the light source switch 35, the light sources 34 can perform various light-emitting modes to enhance the visual effects.

What is claimed is:

1. A light-emitting shoe, comprising:
a shoe body comprising an upper and a shoe sole mounted to a bottom side of said upper, said upper being made up of a woven fabric composed of a plurality of warp yarns, a plurality of weft yarns and a plurality of fiber optic yarns, said shoe sole comprising an accommodation chamber shielded by said upper; and
a light source mounted in said accommodation chamber of said shoe sole of said shoe body and connected to one end of each said fiber optic yarn for emitting light into said fiber optic yarns so that the emitted light of said light source is evenly distributed throughout said upper of said shoe body via said fiber optic yarns.

2. The light-emitting shoe as claimed in claim 1, further comprising a battery and a circuit board mounted in said accommodation chamber of said shoe sole of said shoe body, said circuit board being electrically coupled with said battery and said light source.

3. The light-emitting shoe as claimed in claim 2, wherein said shoe body further comprising a tongue stitched to said upper, and a light source switch mounted to said tongue and electrically connected to said circuit board.

4. The light-emitting shoe as claimed in claim 1, wherein said upper of said shoe body comprises a counter, and an opening located in one side of said counter in communication with said accommodation chamber of said shoe sole; each said fiber optic yarn has one end thereof inserted through said opening and connected to said light source with a buckle.

5. The light-emitting shoe as claimed in claim 1, further comprising a beam tube holding respective one ends of said fiber optic yarns in place.

6. The light-emitting shoe as claimed in claim 1, wherein each said warn yarn and each said fiber optic yarn of said woven fabric are interlaced with said weft yarns.

7. The light-emitting shoe as claimed in claim 1, wherein said warp yarns and said fiber optic yarns are alternatively interlaced with said weft yarns.
